(19) United States
(12) Patent Application Publication
(10) Pub. No.: US 2008/0006959 A1
(43) Pub. Date: Jan. 10, 2008

(54) TWO-SHOT COMPONENT AND METHOD OF MAKING THE SAME

(75) Inventors: David J. Dooley, Troy, MI (US); David F. Turczynski, Highland, MI (US); Glenn A. Cowelchuk, Chesterfield Township, MI (US)

Correspondence Address: BROOKS KUSHMAN P.C.;INTL. AUTOMOTIVE COMPONENTS GROUP, 1000 TOWN CENTER, TWENTY-SECOND FLOOR, SOUTHFIELD, MI, 48075, US

(73) Assignee: LEAR CORPORATION, Southfield, MI (US)

(21) Appl. No.: 11/456,263

(22) Filed: Jul. 10, 2006

(51) Int. Cl. B29C 45/16

(52) U.S. Cl. 264/102; 264/255; 425/577

(57) ABSTRACT

The present invention relates to an automobile interior trim panel, and a method and a tool for making the same. In at least one embodiment, the method comprises providing a first mold half and a second mold half, wherein the first mold half has a protrusion retractable between a first position in contact with the second mold half and a second position spaced from the second mold half. The first and second mold halves, when the protrusion is in the first position, cooperates to form a first mold cavity. The method further comprises introducing a first resin into the first mold cavity to form a panel subassembly circumscribing the protrusion. The method further comprises moving the protrusion towards the second position to reveal an opening in the panel subassembly and forming a panel portion on a portion of the upper surface of the panel subassembly.

### BACKGROUND OF THE INVENTION

1. Field of the Invention

The present invention is related to a two-shot trim component and method of making the same.

2. Background Art

Motor vehicle interiors have many interior components made of trim panels. One of the more relatively common types of interior components is an interior door panel.

Some of the more common interior door panels comprise a rigid door panel substrate and a relatively soft bolster. In these types of door panels the bolster is typically disposed above an armrest of the door panel and below an upper edge of a door. The bolster typically provides a decorative and/or soft area to a portion of the door panel above the armrest.

In a typical door panel manufacturing process, the bolster, and the rigid door panel substrate are formed separately and heat staked or attached via other suitable attachment mechanisms to form a door panel. Such a manufacturing process requires a secondary operation such as heat staking. Also, due to the inherent give between the heat staked bolster and the door panel substrate, rattling and squeaking can occur during operation of the vehicle.

Accordingly, it would be desirable to provide a trim panel having a decorative trim portion, such as a door bolster, which would overcome at least one of the deficiencies in the prior art.

### SUMMARY OF THE INVENTION

According to one aspect of the present invention, a method of making an automobile interior trim panel is provided. In at least one embodiment, the method comprises providing a molding tool comprising a first mold half and a second mold half. The first mold half has a protrusion retractable between a first position in contact with the second mold half and a second position spaced from the second mold half. The first and second mold halves, when the protrusion is in the first position, cooperates to form a first mold cavity. In at least this embodiment, the method further comprises introducing a first resin into the first mold cavity, wherein the resin, upon cooling, forms a panel subassembly circumscribing the protrusion and having an upper surface facing the second mold half and a lower surface facing the first mold half. In at least this embodiment, the method further comprises moving the protrusion towards the second position to reveal an opening in the panel subassembly. In at least this embodiment, the method further comprises providing the panel subassembly within the first mold half and a third mold half, wherein the first mold half, the third mold half, and the panel subassembly form a second mold cavity and introducing a second resin, less rigid that the first resin, into the second mold cavity, wherein the second resin, upon cooling, forms a resilient panel portion on a portion of the upper surface of the panel subassembly.

In at least one embodiment of the present invention, the method further comprises venting gases created during the introducing a second resin step through the opening in the panel subassembly towards the first mold half.

In at least another embodiment of the present invention, the method further comprises venting the gases out of the first mold half.

In still at least yet another embodiment of the present invention, the first mold half includes a mold channel for venting the gases out of the first mold half.

In at least one embodiment of the present invention, the second cavity comprises a first portion above the panel subassembly, a second portion below the panel subassembly, and a third portion extending between and connecting the first and second portions.

In at least another embodiment of the present invention, the first portion of the second cavity comprises 95 to 99.9%, by volume, of the second cavity. In at least yet another embodiment, the first portion of the second cavity comprises 96 to 99.5%, by volume, of the second cavity. In still yet another embodiment, the first portion of the second cavity comprises 97 to 99%, by volume, of the second cavity.

In at least one embodiment of the present invention, the first resin comprises a thermoplastic resin. In at least another embodiment of the present invention, the first resin is selected from the group consisting of thermoplastic polyurethanes, thermoplastic olefins, polyvinyl chloride, polypropylene, and combinations thereof. In at least yet another embodiment of the present invention, the first resin is selected from the group consisting of homopolymers and copolymers of polyethylene, homopolymers and copolymers of polypropylene, filled polypropylene, polycarbonate, acrylonitrile butadiene styrene, mixed acrylonitrile butadiene styrene and polycarbonate, and combinations thereof.

In at least one embodiment, the first resin is injected into the mold cavity at a temperature from 350° F. to 600° F. and a pressure from about 200 psi to about 2100 psi.

In at least one embodiment of the present invention, the second resin comprises a thermoplastic resin. In at least another embodiment of the present invention, the second resin is selected from the group consisting of homopolymers and copolymers of polyethylene, homopolymers and copolymers of polypropylene, filled polypropylene, thermoplastic olefins, thermoplastic urethanes, polycarbonate, acrylonitrile butadiene styrene, mixed acrylonitrile butadiene styrene and polycarbonate, and combinations thereof. In yet another embodiment of the present invention, the second resin comprises an elastomer. In still yet another embodiment of the present invention, the second thermoplastic resin is selected from the group consisting of thermoplastic elastomers, styrene-ethylene-butylene-styrene elastomers, blocked copolymer thermoplastic elastomers, polyolefin-based elastomers, foamed thermoplastic elastomers, and combinations thereof.

In at one embodiment of the present invention, the second resin is injected into the mold cavity at a temperature from about 350° F. to about 600° F. and a pressure from about 200 psi to about 2100 psi.

In yet another embodiment, the method of making an interior trim panel comprises providing a molding tool comprising a first mold half and a second mold half, with the first mold half having a protrusion retractable between a first position in contact with the second mold half and a second position spaced from the second mold half, with the first and second mold halves, when the protrusion is in the first position, cooperating to form a first mold cavity. In at least this embodiment, the method further comprises introducing a first resin into the first mold cavity, wherein the resin, upon cooling, forms a panel subassembly circumscribing the protrusion and having an upper surface facing the second mold half and a lower surface facing the first mold half. In at least this embodiment the method further comprises moving the protrusion towards the second position to reveal an opening in the panel subassembly, and providing the panel subassembly within a second mold cavity formed at least by the first mold half, with the second mold cavity having a first portion above the panel subassembly, a second portion below the panel subassembly, and a third portion extending between and connecting the first and second portions, wherein the first portion of the second cavity comprises 95 to 99.9% by volume, of the second cavity. In at least this embodiment, the method further comprises introducing a second resin into the second mold cavity, wherein the second resin, upon cooling, forms a panel portion on a portion of the upper surface of the panel subassembly.

According to yet another aspect of the present invention, an automobile door panel is provided. In at least one embodiment, the automobile door panel is made in accordance with at least one of the methods described above.

While exemplary embodiments in accordance with the invention are illustrated and disclosed, such disclosure should not be construed to limit the claims. It is anticipated that various modifications and alternative designs may be made without departing from the scope of the invention.

### BRIEF DESCRIPTION OF THE DRAWINGS

FIG. 1 is an idealized side view of an automobile interior panel made in accordance with an embodiment of the present invention;

FIG. 2 is a fragmentary sectional view of the automobile interior panel shown in FIG. 1, taken through line 2-2;

FIG. 3 is an illustration of a first mold half cooperating with a second mold half to form a first mold cavity;

FIG. 4 is a fragmentary sectional view of the first mold half shown in FIG. 2, taken through line 4-4 showing the introduction of resin into the mold cavity; and

FIG. 5 is a view similar to FIG. 3 showing the introduction of a resin into a second cavity.

### DETAILED DESCRIPTION OF THE PREFERRED EMBODIMENT(S)

As required, detailed embodiments of the present invention are disclosed herein. However, it is to be understood that the disclosed embodiments are merely exemplary of the invention that may be embodied in various alternative forms. The figures are not necessarily of scale, some features may be exaggerated or minimized to show details of particular components. Therefore specific structural and functional details disclosed herein are not to be interpreted as limiting, but merely as a representative basis for the claims and/or a representative basis for teaching one skilled in the art to variously employ the present invention.

Moreover, except where otherwise expressly indicated, all numerical quantities in this description and in the claims are to be understood as modified by the word “about” in describing the broader scope of this invention. Practice within the numerical limits stated is generally preferred. Also, unless expressly stated to the contrary, the description of a group or class of materials as suitable preferred for a given purpose in connection with the invention implies that mixtures of any two or more members of the group or class may be equally suitable or preferred.

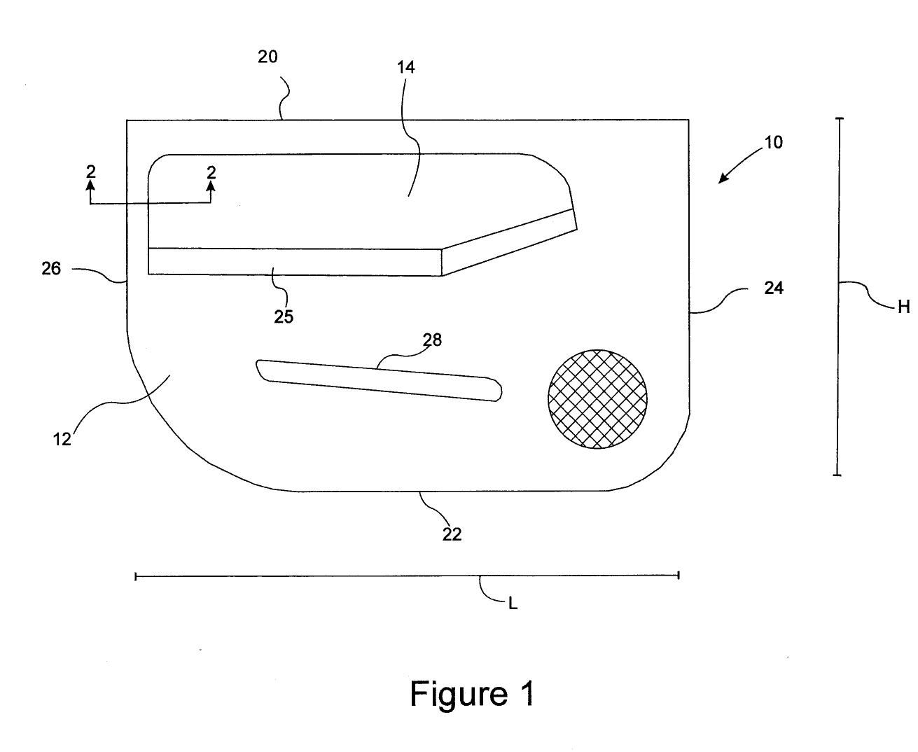

FIG. 1 shows an interior door panel 10 in accordance with at least one embodiment of the present invention. Certain aspects of the present invention will be described below in connection with the door panel 10. However, it should be understood that other trim products, such as instrument panels, glove box door covers, console sides, console covers, pillar trim panels, shelves, trim covers and the like may also enjoy the benefits of the present invention.

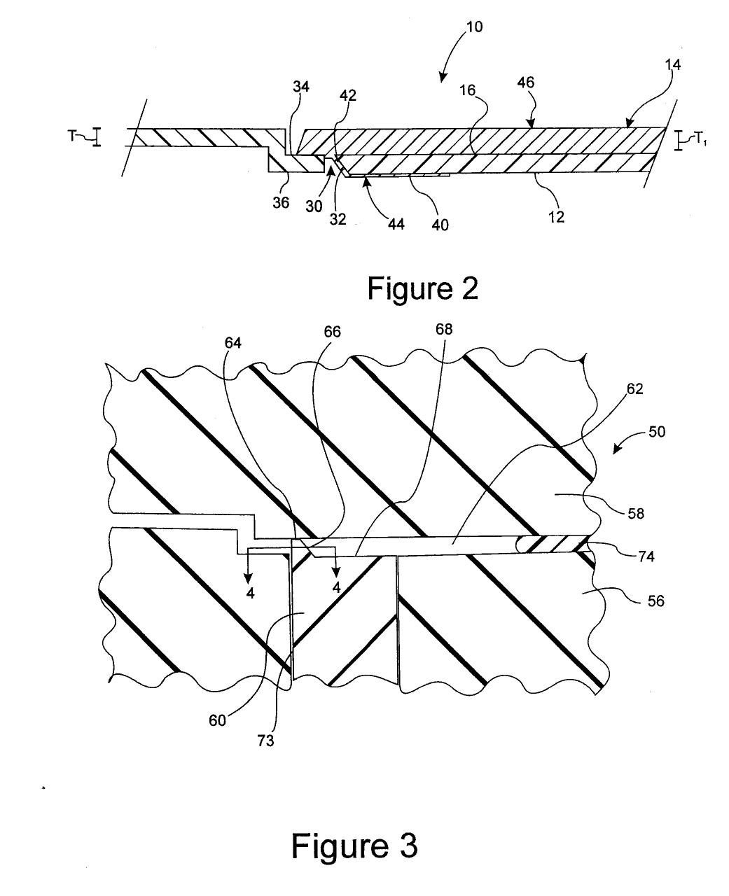

Referring to FIGS. 1 and 2, door panel 10 includes a rigid major panel portion 12 and a bolster 14 secured to the major panel portion 12. In at least one embodiment, the bolster 14 is made of a less rigid material than the major panel portion 12. The bolster 14 is disposed over, and in at least one embodiment, covers an upper portion of the major panel portion 12. This is to provide a soft feel and/or a contrasting color to the upper portion of the major panel portion 12 relative to the remainder of the main panel portion 12.

The major panel portion 12 may also include additional structures attached thereto, such as attachment features. Referring again to FIG. 1, the door panel 10 can also include additional components such as an armrest 25 and a map pocket 28. In at least the embodiment illustrated in FIG. 1, the armrest 25 is secured to the major panel portion 12 and the map pocket 28 is formed in the major panel portion 12.

In at least one embodiment, the major panel portion 12 has a height H of 25 to 125 cm, and in another embodiment of 50 to 75 cm. In at least one embodiment, the major panel portion 12 has a length L of 25 to 200 cm, and in another embodiment of 70 to 115 cm.

In at least one embodiment, the major panel portion 12 has a thickness T of 1 to 5 mm, and in other embodiments of 2.5 to 3.5 mm. In at least one embodiment, the bolster 14 has a thickness T₁ of 0.5 to 3 mm, and in other embodiments of 1 to 1.5 mm.

The major panel portion 12 includes a target area 16, generally denoted in the location of the bolster 14, for receipt of the bolster 14. The major panel portion 12 also includes an upper edge 20, an opposed lower edge 22, a forward edge 24, and an opposed rearward edge 26.

The major panel portion 12 also includes an opening 30. The opening 30 can be at any suitable location. However, in at least one embodiment, the opening 30 is located towards the rearward edge 26. In at least another embodiment, the opening 30 is located 5 to 25% of the length L or Height H from an edge of the major panel portion 12. In other embodiments, the opening 30 is located 5 to 20% of the length L or height H from an edge of the major panel-portion, and in yet other embodiments 10 to 15% of the length L or height H, from an edge of the major panel portion 12. In the illustrated embodiment, the edge of the opening 30 is located near is the rearward edge 26. However, it should be understood that the edge could alternatively, or additionally, be any of the other edges 20 to 24.

The opening 30 is relatively small and is primarily for allowing gas to vent during molding of the bolster 14. The opening 30 can be any suitable shape. However, in at least one embodiment, the opening 30 is circular. The opening 30 can be any suitable size, however, in at least one embodiment, the opening 30 is 0.1 to 10 mm in diameter. In other embodiments 0.5 to 8 mm in diameter, and in yet other embodiments 1 to 2.5 mm in diameter. While the size of the opening 30 is referred to as the diameter, it should be understood that if the opening is another shape, that the above sizes represent lengths from one side of the opening to the opposite side of the opening, regardless of the shape. Moreover, more than one opening 30 could be provided to provide additional venting locations.

As can be seen in FIG. 2, the opening 30 includes an angled surface 32 extending between an upper surface 34 of a lower surface 36 of the major panel portion 12. The angled surface 32 helps to vent gases and limit material thickness variations which otherwise could be seen on the “A” surface of the door panel 10.

The bolster 14 also includes a minor spot portion 40 located on the lower surface 36 of the major panel portion 12 and a connector portion 42 extending between connecting the bolster 14 and the minor spot portion 40. The minor spot portion 40 and the connector portion 42 of the bolster 14 collectively comprise a rear portion 44 of the bolster 14. The remainder of the bolster 14 comprises an upper portion 46. The rear portion 44 can be any suitable size, however, in at least one embodiment, the rear portion comprises 0.5 to 2% by weight, of the total weight of the bolster 14, in other embodiments 0.75 to 1.5%, in yet other embodiments 1 to 1.25%. In at least one embodiment, the portion of the bolster 14 above the upper surface 34 of the major panel portion 12 comprises 95 to 99.9%, by volume or weight, of the total volume or weight of the bolster, in other embodiments 96 to 99.5%, by volume or weight, and in yet other embodiments 97 to 99%, by volume or weight.

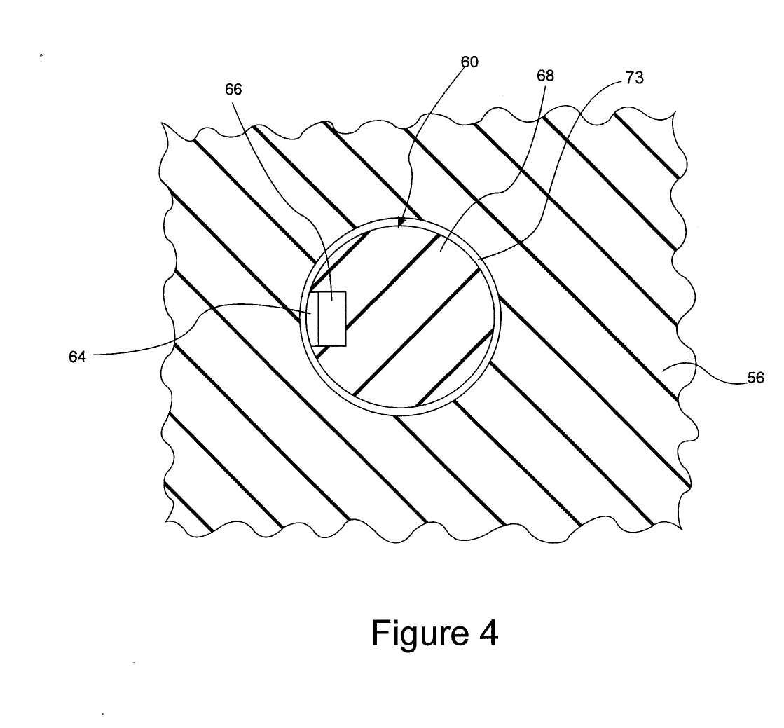

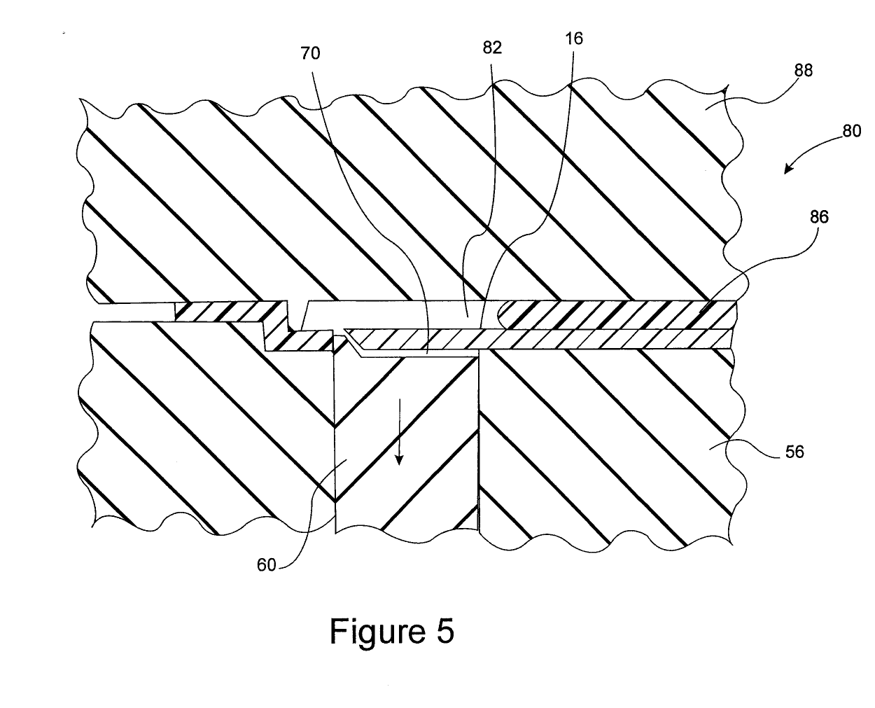

Referring to FIGS. 3, 4 and 5, a method of making a door panel 10 in accordance with the present invention will be described. FIG. 3 illustrates a mold tool 50 having core half 56 and a first cavity half 58. The core half 56 includes a retractable protrusion 60. The retractable protrusion 60 is movable between a first position where the protrusion abuts the first cavity half 58 (FIG. 3), and a second position, where the protrusion is spaced from the upper surface 34 of the major panel portion 12. In at least the illustrated embodiment, the projection 60 includes an upper abutment surface 64, a spaced apart main surface 68, and an angled surface 66 extending therebetween.

As shown in FIG. 3, when mold tool 50 is closed (i.e., the core half 56 and the cavity half 58 are brought together and the protrusion 60 is in the first position), a first cavity 62 is formed within the mold tool 50. As can best be seen in FIG. 5, when the projection 60 is in the second position, the angled surface 66 of the projection 60 cooperates with the angled surface 32 of the major panel portion 12, and the main surface of the projection 60 cooperates with the lower surface 36 of the major panel portion 12 to form a channel 70 that cooperates with the opening 30 to expel gas during molding. In other words, the opening 30 and the channel 70 enable gas to travel from the upper surface 34, through the opening 30 and the channel 70, towards the core half 56. In at least one embodiment, the core half 56 has a passage (not shown) for venting these gases out of the core half 56.

When the mold tool 50 is closed (FIG. 3), resin 74 is introduced into the mold cavity 62. Typically, the resin 74 is injected into the mold cavity 62 at a temperature from about 350° F. to about 600° F. and a pressure from about 200 psi to about 2100 psi. It should be appreciated that these temperature and pressure ranges will vary depending on the materials used. The resin 74 flows through the mold cavity 62 filling the mold cavity 62, as can be understood from FIG. 5. The resin 74 upon cooling, or curing, forms major panel portion 12.

As shown in FIG. 5, the major panel portion 12 is positioned within a second mold 80 forming a second mold cavity 82. The second mold cavity 82 is generally positioned above the target area 16 of the major panel portion 12. The protrusion 60 is retracted towards the second position to reveal the opening 30 in the major panel portion 12. The opening 30 provides fluid communication between the second mold cavity 82 and the channel 70. The core half 56 includes a passage (now shown) that communicates with the channel 70 to vent gases out of tool 80. In at least one embodiment, the portion of the second cavity 82 above the upper surface 34 of the major panel portion 12 comprises 95 to 99.9%, by volume, of the total volume of the second cavity, in at least another embodiment, 96 to 99.5%, and in yet another embodiment, 97 to 99%.

A second resin 86 is introduced into the second mold cavity 82. Typically, the second resin 86 is injected into second mold cavity 82 at a temperature from about 350° F. to about 600° F. and a pressure from about 200 psi to about 2100 psi. It should be appreciated that these temperature and pressure ranges will vary depending on the materials used. It should be appreciated that the core half 56 and cavity half 58 (illustrated in FIG. 3) may include moveable sections that are individually positionable to form the second mold cavity 82. Alternatively, as is shown in FIG. 5, cavity half 88 may be replaced with a substitute cavity half 88 specifically designed to form the second mold cavity 82. The second resin 86, upon cooling, or curing, forms the bolster 14 secured to the major panel portion 12.

As the second resin 86 is traveling along upper surface 34 of the major panel portion 12, gases, along with some of the overmold material, can vent through the opening 30 and into passage 70 away from the upper surface 34 of the major panel portion 12. These gases are then able to be vented out of the mold tool 80, in at least one embodiment, via a passage in the core half 56 that communicates with passage 70. In at least one embodiment, the space 73 between the protrusion/pin 60 and the core half 56 communicates with passage 70 to provide the passage 73 for the gases to vent out of the mold tool 80. The removal of these gases from the upper surface 34 enables the bolster 14 to be formed without any gases being trapped. Since trapped gases can cause relatively high resistant forces on resin during filling that can cause relatively high cavity pressure, by venting the gases out of the mold tool 80, the resin can relatively easily fill the cavity 62, among other benefits.

In at least one embodiment, the major panel portion 12 can be made of any suitable resin 74 such as a relatively hard, relatively rigid resin. Typically, useful resins 74 for the major panel portion 12 are thermoplastic resins. Particularly useful resins 74 for the major panel portion 12 include, for example, thermoplastic polyurethanes, thermoplastic olefins, polyvinyl chloride, polypropylene, and combinations thereof. More specific examples of useful resins 74 for the major panel portion 12 include homopolymers and copolymers of polyethylene, homopolymers and copolymers of polypropylene, filled polypropylene, polycarbonate, acrylonitrile butadiene styrene, mixed acrylonitrile butadiene styrene and polycarbonate, and combinations thereof.

In at least one embodiment, the major panel portion 12 and the bolster 14 are made of different materials to provide a different appearance and/or feel between the major panel portion 12 and the bolster 14. The bolster 14 can be made of any suitable resin 86. Typically useful resins 86 for the bolster 14 are thermoplastic resins. Useful resins 86 include, for example, thermoplastic polyurethanes, thermoplastic olefins, polyvinyl chloride, polypropylene, and combinations thereof. More specific examples of useful resins 86 for the bolster 14 include homopolymers and copolymers of polyethylene, homopolymers and copolymers of polypropylene, polycarbonate, acrylonitrile butadiene styrene, mixed acrylonitrile butadiene styrene and polycarbonate, and combinations thereof. Since the bolster 14 is usually softer than the door panel portions 12 the resin 86 for the bolster 14 may also comprise one or more elastomers. Examples of useful elastomers for the bolster 14 include thermoplastic elastomers, styrene-ethylene-butylene-styrene elastomers, blocked copolymer thermoplastic elastomers, polyolefin-based elastomers, foamed thermoplastic elastomers, and combinations thereof. Also, the second resin 86 could result in a different color than the first resin 74. In at least one embodiment, the first resin 74 comprises TPO and the second resin 86 comprises TPE.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of making an automobile interior trim panel, said method comprising:
a) providing a molding tool comprising a first mold half and a second mold half, the first mold half having a protrusion retractable between a first position in contact with the second mold half and a second position spaced from the second mold half, the first and second mold halves, when the protrusion is in the first position, cooperating to form a first mold cavity;
b) introducing a first resin into the first mold cavity, the resin, upon cooling, forming a panel subassembly circumscribing the protrusion, the panel subassembly having an upper surface facing the second mold half and a lower surface facing the first mold half;
c) moving the protrusion towards the second position to reveal an opening in the panel subassembly;
d) providing the panel subassembly within the first mold half and a third mold half, the first mold half, the third mold half, and the panel subassembly forming a second mold cavity; and
e) introducing a second resin less rigid that the first resin into the second mold cavity, the second resin, upon cooling, forming a resilient panel portion on a portion of the upper surface of the panel subassembly.

2. The method of claim 1 further comprising venting gases created during step (e) through the opening in the panel subassembly towards the first mold half.

3. The method of claim 2 wherein the second cavity comprises a first portion above the panel subassembly, a second portion below the panel subassembly, and a third portion extending between and connecting the first and second portions, the second and third portions of the second cavity communicating with the opening to vent the gases towards the first mold half.

4. The method of claim 3 wherein the first portion of the second cavity comprises 95 to 99.5%, by volume, of the second cavity.

5. The method of claim 2 further comprising venting the gases out of the first mold half.

6. The method of claim 5 wherein the first mold half includes a mold channel for venting the gases out of the first mold half.

7. The method of claim 6 wherein the projection cooperates with the panel subassembly to form the second and third portions of the second cavity.

8. The method of claim 7 wherein the projection has an angled surface and the panel subassembly has an angled surface, the projection angled surface and the panel subassembly angled surface cooperating to form the third portion of the second cavity.

9. The method of claim 1 wherein the first mold cavity has a length L and a generally transverse height H, and the first mold half includes a cavity to receive at least a portion of the projection when the projection is in the second position, and the opening is 5 to 20% of the length L or height H from an edge of the first cavity.

10. The method of claim 3 wherein the first resin is selected from the group consisting of homopolymers and copolymers of polyethylene, homopolymers and copolymers of polypropylene, filled polypropylene, polycarbonate, acrylonitrile butadiene styrene, mixed acrylonitrile butadiene styrene and polycarbonate, and combinations thereof.

11. The method of claim 10 wherein the second thermoplastic resin is selected from the group consisting of thermoplastic elastomers, styrene-ethylene-butylene-styrene elastomers, blocked copolymer thermoplastic elastomers, polyolefin-based elastomers, foamed thermoplastic elastomers, and combinations thereof.

12. The method of claim 11 wherein the first resin is injected into the second mold cavity at a temperature from 350° F. to 440° F. and a pressure from about 200 psi to about 2100 psi.

13. An automobile door panel made by the method of claim 1.

14. A method of making an automobile interior trim panel, said method comprising:
a) providing a molding tool comprising a first mold half and a second mold half, the first mold half having a protrusion retractable between a first position in contact with the second mold half and a second position spaced from the second mold half, the first and second mold halves, when the protrusion is in the first position, cooperating to form a first mold cavity;
b) introducing a first resin into the first mold cavity, the resin, upon cooling, forming a panel subassembly circumscribing the protrusion, the panel subassembly having an upper surface facing the second mold half and a lower surface facing the first mold half;
c) moving the protrusion towards the second position to reveal an opening in the panel subassembly;
d) providing the panel subassembly within a second mold cavity formed by at least the first mold half, the second mold cavity comprising a first portion above the panel subassembly, a second portion below the panel subassembly, and a third portion extending between and connecting the first and second portion, wherein the first portion of the second cavity comprises 95 to 99.9%, by volume, of the second cavity; and
e) introducing a second resin into the second mold cavity, the second resin, upon cooling, forming a panel portion on a portion of the upper surface of the panel subassembly.

15. The method of claim 14 further comprising venting gases created during step (e) through the opening in the panel subassembly towards the first mold half.

16. The method of claim 15 further comprising venting the gases out of the first mold half.

17. The method of claim 16 wherein the first mold half includes a mold channel for venting the gases out of the first mold half.

18. The method of claim 17 wherein the projection cooperates with the panel subassembly to form the second and third portions of the second cavity.

19. The method of claim 18 wherein the projection has an angled surface and the panel subassembly has an angled surface, the projection angled surface and the panel subassembly angled surface cooperating to form the third portion of the second cavity.

20. An apparatus for molding an automotive trim part, said apparatus comprising:
a first mold half and a second mold half, the first mold half having a protrusion retractable between a first position in contact with the second mold half and a second position spaced from the second mold half, the first and second mold halves, when the protrusion is in the first position, cooperating to form a first mold cavity;
the first mold cavity capable of receiving a first resin which, upon cooling, forms a panel subassembly circumscribing the protrusion, the panel subassembly having an upper surface facing the second mold half and a lower surface facing the first mold half;
the protrusion being movable towards the second position to reveal an opening in the panel subassembly;
the apparatus capable of forming a second cavity having a first portion above the panel subassembly, a second portion below the panel subassembly, and a third portion extending between and connecting the first and second portions, the second and third portions of the second cavity communicating with the opening to vent the gases towards the first mold half; and
the second mold cavity capable of receiving a second resin which, upon cooling, forms a panel portion on a portion of the upper surface of the panel subassembly.
